(19) United States
(12) Patent Application Publication
(10) Pub. No.: US 2024/0393563 A1
(43) Pub. Date: Nov. 28, 2024

(54) LENS ASSEMBLY AND PROJECTOR

(71) Applicant: GOERTEK OPTICAL TECHNOLOGY CO., LTD., Weifang,Shandong (CN)

(72) Inventors: Shulin Tao, Shandong (CN); Huabin Chen, Shandong (CN)

(73) Assignee: GOERTEK OPTICAL TECHNOLOGY CO., LTD., Weifang,Shandong (CN)

(21) Appl. No.: 18/697,233

(22) PCT Filed: Dec. 10, 2021
(86) PCT No.: PCT/CN2021/137105

§ 371 Date: Mar. 29, 2024

(30) Foreign Application Priority Data
Sep. 30, 2021 (CN) 202111169090.3

(51) Int. Cl. G02B 7/02; G02B 13/16; G03B 21/14

(52) U.S. Cl. CPC G02B 7/028; G02B 13/16; G03B 21/142

(57) ABSTRACT

The disclosure includes a lens assembly and a projector. The lens assembly comprises a mounting base, a lens, and a thermal compensation structure. The mounting base is provided with an accommodation cavity. The lens penetrates through the mounting base and is movably provided therein, an outer peripheral wall of the lens being provided with a boss, the boss being located in the accommodation cavity for dividing the accommodation cavity into a first chamber and a second chamber. The thermal compensation structure comprises an expansion member and an elastic member, the expansion member and the elastic member being respectively accommodated and confined in the first chamber and the second chamber, the elastic member being configured to coordinate with the expansion member to drive the boss to actuate the lens to move axially when the lens is heated.

### CROSS-REFERENCE TO RELATED APPLICATIONS

The present disclosure is a National Stage of International Application No. PCT/CN2021/137105, filed on Dec. 10, 2021, which claims priority to Chinese Patent Application No. 202111169090.3, filed on Sep. 30, 2021, both of which are hereby incorporated by reference in their entireties.

### TECHNICAL FIELD

The present disclosure relates to the field of projection technologies, and in particular to a lens assembly and a projector.

### BACKGROUND

A lens is commonly used in projection systems as a terminal module that receive light sources and output projection images, and is somewhat a determinant for the projection imaging quality of a projection system.

In the related art, after the lens is installed and fixed within the projection system, the imaging surface of the lens is located within the projection system. When the projection system is working, it generates a large amount of heat, which will be transferred to the lens and cause thermal expansion of optical pieces in the lens, resulting in a shift of the lens's imaging surface and causing thermal defocus and thermal out-of-focus. Accordingly, the clarity of the projection image projected outward through the lens degrades.

### SUMMARY

The present disclosure mainly intends to propose a lens assembly aiming at ameliorating thermal defocus and thermal out-of-focus of the lens and improving the projection imaging quality of the lens.

To achieve the above objectives, the present disclosure proposes a lens assembly, comprising:

A mounting base provided with an accommodation cavity:

A lens penetrating through the mounting base and movably provided therein, an outer peripheral wall of the lens being provided with a boss, the boss being located in the accommodation cavity and dividing the accommodation cavity into a first chamber and a second chamber; and

A thermal compensation structure comprising an expansion member and an elastic member, the expansion member and the elastic member being respectively accommodated and confined in the first chamber and the second chamber, the elastic member being in a compressed state and configured to coordinate with the expansion member to drive the boss to cause the lens to move axially when the lens heats up, in order to compensate for the deviation of the imaging surface of the lens.

In an embodiment of the present disclosure, the mounting base is provided with a mounting hole in communication with the accommodation cavity, the lens penetrating through the mounting hole and being movably provided therein:

One end of the expansion member distal to the boss abuts against a circumference of the mounting hole, and one end of the elastic member distal to the boss abuts against a bottom wall of the accommodation cavity: or

One end of the elastic member distal to the boss abuts against a circumference of the mounting hole, and one end of the expansion member distal to the boss abuts against a bottom wall of the accommodation cavity.

In an embodiment of the present disclosure, the expansion member and the elastic member are of an annular structure, and the expansion member and the elastic member are sleeved on the outer peripheral wall of the lens.

In an embodiment of the present disclosure, an outer peripheral wall of the boss slidably abuts against an inner peripheral wall of the accommodation cavity, and the expansion member fills the first chamber or the second chamber.

In an embodiment of the present disclosure, the expansion member comprises two expansion blocks accommodated and confined in the first chamber or the second chamber, and symmetrically arranged with an optical axis of the lens as an axis of symmetry:

Alternatively, the expansion member comprises a plurality of expansion blocks accommodated and confined in the first chamber or the second chamber, and arranged evenly surrounding the lens.

In an embodiment of the present disclosure, the expansion blocks are each of the same linear expansion coefficient.

In an embodiment of the present disclosure, the elastic member comprises two springs accommodated and confined in the first chamber or the second chamber, and symmetrically arranged with an optical axis of the lens as the axis of symmetry:

Alternatively, the elastic member comprises a plurality of springs accommodated and confined in the first chamber or the second chamber, and arranged evenly surrounding the lens.

In an embodiment of the present disclosure, the mounting base comprises a base body provided with an accommodation slot, and
a cover body detachably covering a slot mouth of the accommodation slot, the cover body cooperating with a slot wall of the accommodation slot to enclose the accommodation cavity.

In an embodiment of the present disclosure, the base body is further provided with an assembling hole penetrating through one side of the base body facing away from the cover body and penetrating through a bottom wall of the accommodation slot, the assembling hole being used for installing a sensor.

In addition, the present disclosure also proposes a projector including the lens assembly as described above.

The technical solution of the present disclosure is to allow the lens penetrate through the mounting base and movably provided therein, provide a boss on the lens, the boss being located in an accommodation cavity of the mounting base and dividing the accommodation cavity into a first chamber and a second chamber, and allow an elastic member and an expansion member respectively accommodated and confined in the first chamber and the second chamber. In this way, the elastic member and the expansion member respectively abut against the boss along the axial direction of the lens: when the expansion member heats up and expands, it will drive the boss to cause the lens to move in the axial direction, while the elastic member is compressed. Provision of the elastic member offers conditions for the expansion member to expand linearly along the axial direction of the lens, allowing the expansion member to cause the lens to move a certain displacement distance in the axial direction when it expands, which cancels out the displacement distance of the lens imaging surface, thus achieving adaptive compensation for the displacement of the lens imaging surface. This allows the imaging surface of the lens to maintain at the same position as that before the lens heats up, solving the problem of thermal defocus and thermal out-of-focus of the lens, and improving the image projection quality of the lens.

### BRIEF DESCRIPTION OF THE DRAWINGS

In order to clearly illustrate the technical solutions in the embodiments of the present disclosure or the prior art, the figures required for describing the embodiments or the prior art will be briefly introduced below. It is obvious that the figures described below are only a few embodiments of the present disclosure. For those skilled in the art, other figures can be obtained based on the structures shown in these figures without creative work.

FIG. 1 is a structural illustration of a lens assembly according to an embodiment of the present disclosure;

FIG. 2 is a structural illustration of a lens assembly according to another embodiment of the present disclosure:

FIG. 3 is a structural illustration of a lens assembly according to another embodiment of the present disclosure:

FIG. 4 is a structural illustration of a lens assembly in yet another embodiment of the present disclosure:

FIG. 5 is a structural illustration of the mounting base in FIG. 1.

### REFERENCE SIGNS

TABLE 0001

| Reference | | Reference | |
|---|---|---|---|
| Sign | Name | Sign | Name |
| 1 | Mounting base | 1c | Assembling hole |
| 11 | Base body | 2 | Lens |
| 12 | Cover body | 21 | Boss |
| 1a | Accommodation cavity | 3 | Thermal compensation |
| | | | structure |
| 1a1 | First chamber | 31 | Expansion member |
| 1a2 | Second chamber | 32 | Elastic member |
| 1b | Mounting hole | 4 | Sensor |

The implementation, functional characteristics, and advantages of the present disclosure will be further explained in conjunction with the embodiments, with reference to the accompanying drawings.

### DETAILED DESCRIPTION

The technical solutions in the embodiments of the present disclosure will be clearly and completely described below in conjunction with the accompanying drawings. It is apparent that the described embodiments are only a part of the embodiments of the present disclosure, rather than all of them. Based on the embodiments of the present disclosure, all other embodiments obtained by those skilled in the art without creative work fall within the scope of protection of the present disclosure.

It should be noted that all directional indications (such as up, down, left, right, front, back, etc.) in the embodiments of the present disclosure are only used to explain the relative positional relationships and motion conditions between various components in a specific posture (as shown in the accompanying drawings). If the specific posture changes, the directional indications will also change accordingly.

In the present disclosure, unless otherwise specifically defined and limited, the terms “connected”, “fixed”, etc. shall be broadly understood, for example, “fixed” can be fixed connection, or detachable connection, or integration: it can be mechanical connection, or electrical connection: it can be directly connected, or indirectly connected through intermediate media: it can be the internal communication between two elements or the interaction relationship between two elements, unless otherwise specifically limited. For those of ordinary skill in the art, the specific meaning of the above terms in the present disclosure can be understood according to the specific circumstances.

In addition, in the present disclosure, descriptions involving “first”, “second”, etc. are only for descriptive purposes and shall not be understood as indicating or implying their relative importance or implicitly specifying the number of technical features indicated. Therefore, features defined as “first” and “second” may explicitly or implicitly include at least one of these features. The meaning of “and/or” appearing throughout the text is that it includes three parallel solutions, such as “taking A and/or B as an example”, including A solution, B solution, or a solution where both A and B are satisfied simultaneously. In addition, technical solutions between various embodiments can be combined with each other, but must be based on the ability of those of ordinary skills in the art to implement it. When a combination of technical solutions is contradictory or impossible to implement, it shall be deemed that such a combination of technical solutions does not exist and is not within the scope of protection claimed by the present disclosure.

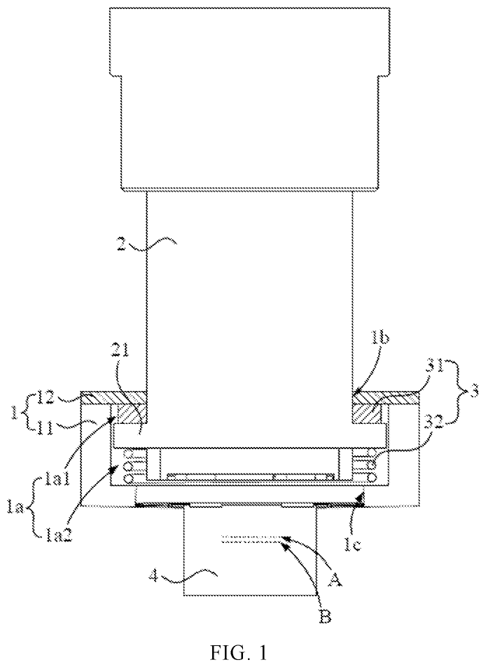

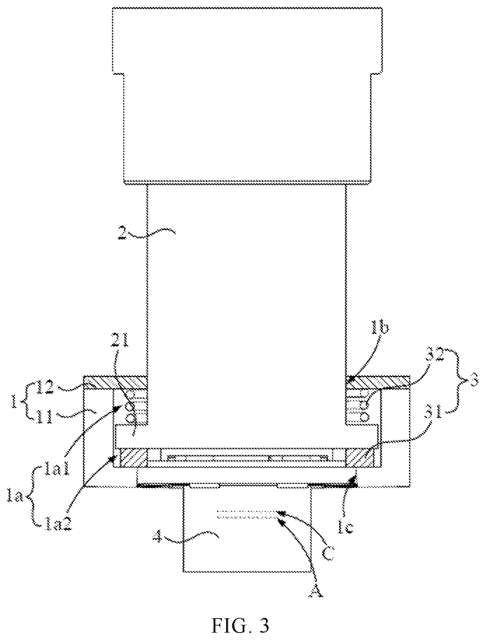

An embodiment of the present disclosure proposes a lens assembly, which is applied to a projector. As shown in FIG. 1 and FIG. 3, the lens assembly includes a mounting base 1, a lens 2, and a thermal compensation structure 3. The mounting base 1 is provided with an accommodation cavity 1a, and the lens 2 penetrates through the mounting base 1 and is movably provided in the mounting base 1. An outer peripheral wall of the lens 2 is provided with a boss 21, the boss 21 being located in the accommodation cavity 1a and divides the accommodation cavity 1a into a first chamber 1a1 and a second chamber 1a2. The thermal compensation structure 3 includes an expansion member 31 and an elastic member 32. The expansion member 31 and the elastic member 32 are respectively accommodated and confined in the first chamber 1a1 and the second chamber 1a2. The elastic member 32 is configured to coordinate with the expansion member 31 to drive the boss 21 to cause the lens 2 to move axially when the lens 2 heats up.

In this embodiment, the mounting base 1 is used to mount and fix the lens assembly. The mounting base 1 can be a housing structure used to mount the lens assembly on the projector. The material of the mounting base 1 can be plastic, metal alloy, etc., which is not limited here. The mounting base 1 is provided therein with an accommodation cavity 1a, which is used to accommodate the thermal compensation structure 3 and part of the structure of the lens 2. The cross-sectional shape of the accommodation cavity 1a can be circular, and the longitudinal cross-sectional shape of the accommodation cavity 1a can be rectangular, so that the accommodation cavity 1a has a good match with the outer shape of the lens 2, improving the fitness and aesthetics appearance of the lens 2 after its assembly with the mounting base 1. At the same time, it is also beneficial to make full use of the space of the accommodation cavity 1a inside the mounting base 1, reducing the volume of the mounting base 1.

The lens 2 is used for projection imaging. The overall structure of the lens 2 is cylindrical. The lens 2 is coaxially equipped therein with multiple optical pieces. The lens 2 has a light-entering side and a light-exiting side. The light-entering side of the lens 2 is located inside the accommodation cavity 1a, and the light-exiting side of the lens 2 is located on an outer side of the mounting base 1.

The boss 21 provided on the outer peripheral wall of the lens 2 is used to abut against and coordinate with the elastic member 32 and the expansion member 31. The boss 21 is an annular structure: alternatively, the boss 21 includes a plurality of protrusion structures. When the boss 21 is an annular structure, the boss 21 is arranged surrounding the outer peripheral wall of the lens 2, and is provided adjacent to the light inlet side of the lens 2. The outer peripheral wall of the boss 21 may slidably abut against the inner peripheral wall of the accommodation cavity 1a to confine the boss 21 and the lens 2 through the inner peripheral wall of the accommodation cavity 1a, so as to avoid lateral deflection of the lens 2 and ensure that the imaging surface of the lens 2 displaces only in the axial direction of the lens 2 when the lens 2 heats up, thus ensuring accuracy and reliability when focusing the lens 2. At this time, the boss 21 divides the accommodation cavity 1a into a first chamber 1a1 and a second chamber 1a2 that are not in communication with each other. When the boss 21 includes a plurality of protrusion structures, the plurality of protrusion structures are arranged on the outer peripheral wall of the lens 2 in a circumferential direction of the lens 2, surrounding the lens 2 and provided adjacent to the light inlet side of the lens 2. One end of the plurality of protrusion structures distal to the lens 2 may slidably abut against the side wall of the accommodation cavity 1a to confine the plurality of protrusion structures and the lens 2 through the inner peripheral wall of the accommodation cavity 1a, so as to avoid lateral deflection of the lens 2 and ensure that the imaging surface of the lens 2 displaces only in the axial direction of the lens 2 when the lens 2 heats up, thus ensuring accuracy and reliability when focusing the lens 2. At this time, the boss 21 divides the accommodation cavity 1a into a first chamber 1a1 and a second chamber 1a2 that are in communication with each other.

The expansion member 31 and the elastic member 32 cooperate to compensate for deviation of the axial imaging surface of the lens 2. Either of the expansion member 31 and the elastic member 32 is located in the first chamber 1a1, and the other of the expansion member 31 and the elastic member 32 is located in the second chamber 1a2. When the expansion member 31 is located in the first chamber 1a1, the expansion member 31 abuts against the top wall of the first chamber 1a1, and the end of the expansion member 31 distal to the first chamber 1a1 abuts against the boss 21, so that the expansion member 31 is clamped and confined between the top wall of the first chamber 1a1 and the boss 21. When the expansion member 31 is located in the second chamber 1a2, the expansion member 31 abuts against the bottom wall of the second chamber 1a2, and one end of the expansion member 31 distal to the bottom wall of the second chamber 1a2 abuts against the boss 21. It can be understood that when the expansion member 31 abuts against the top wall of the first chamber 1a1, both an upper end and a lower end of the elastic member 32 abut against the bottom wall of the second chamber 1a2 and the boss 21, respectively: when the expansion member 31 abuts against the bottom wall of the second chamber 1a2, both the upper end and the lower end of the elastic member 32 abut against the top wall of the first chamber 1a1 and the and boss 21, respectively. The material of the expansion member 31 includes but is not limited to plastic material and metal material, and the elastic member 32 includes but is not limited to a spring and an elastic sleeve.

To better understand this embodiment, the working process of the lens assembly in this embodiment is now described as follows:

As shown in FIG. 1, the dashed line A in the figure shows the imaging surface of the lens 2 before it heats up, and the dashed line B in the figure shows the imaging surface of the lens 2 after it has heated up. That is, the imaging surface of the lens 2 after its heating up has shifted downward along the axis direction of the lens 2. At this time, this embodiment adopts a technical solution of providing the expansion member 31 in the first chamber 1a1 and providing the elastic member 32 in the second chamber 1a2. Accordingly, when the lens assembly is installed on a projector for using, both the lens 2 and the expansion member 31 will heat up, and the imaging surface of the lens 2 will shift downward from the position of the dashed line A to the position of the dashed line B. The expansion member 31 will expand due to heat and push the boss 21 on the lens 2, causing it to move downward. The boss 21 presses the elastic member 32, causing it to compress. The boss 21 also drives the lens 2 to shift downward along the axis of the lens 2, so that the image surface after the lens 2 heats up coincides with the abovementioned image surface after the lens 2 has heated up, thus achieving adaptive compensation for the deviation of the imaging surface of the lens 2 after it has heated up, ensuring the quality of the projection image of the lens 2. Similarly, as shown in FIG. 3, the dashed line A in the figure shows the imaging surface of the lens 2 before it heats up, and the dashed line C in the figure shows the imaging surface of the lens 2 after it has heated up. At this time, when the lens 2 heats up, its imaging surface will shift upward. This embodiment adopts a technical solution of providing the expansion member 31 in the second chamber 1a2 and providing the elastic member 32 in the first chamber 1a1. When both the lens 2 and expansion member 31 heat up, the expansion member 31 will push the boss 21 and cause it to shift upward along its axis, so that the image surface after the lens 2 heats up coincides with the abovementioned image surface after the lens 2 has heated up, thus achieving adaptive compensation for the deviation of the imaging surface of the lens 2 after it has heated up, ensuring the quality of the projection image of the lens 2. In order to ensure that the distance of axial movement of the lens 2 under driving by the expansion member 31 after the expansion of the expansion member 31 equals to the distance of shifting of the imaging surface of the lens 2 after it has heated up, the lens 2 can be heated from temperature T1 up to temperature T2, and the axial shift ΔL of the imaging surface of the lens 2 can be measured and acquired. Then, based on the different linear expansion coefficients of different existing materials, materials that can produce a linear change of ΔL under a temperature change of ΔT=T2−T1 can be found and calculated. The expansion member 31 made of such materials can be applied in this embodiment to obtain a desirable imaging compensation effect for the lens 2.

In a technical solution of the present disclosure, when the expansion member 31 is heated and expands, it drives the boss 21 to cause the lens 2 to move axially, while the elastic member 32 is compressed. The provision of the elastic member 32 provides conditions for the linear expansion of the expansion member 31 along the axis of the lens 2, allowing the expansion member 31, when it expands, to cause the lens 2 to move axially by a certain displacement distance which cancels out the displacement distance of the imaging plane of the lens 2, thus achieving adaptive compensation for the deviation of the imaging plane of the lens 2, so that the imaging plane of the lens 2 can be maintained at the same position as that before the lens 2 heats up, solving the problems of thermal defocus and thermal out-of-focus, and improving the projection image quality of the lens 2.

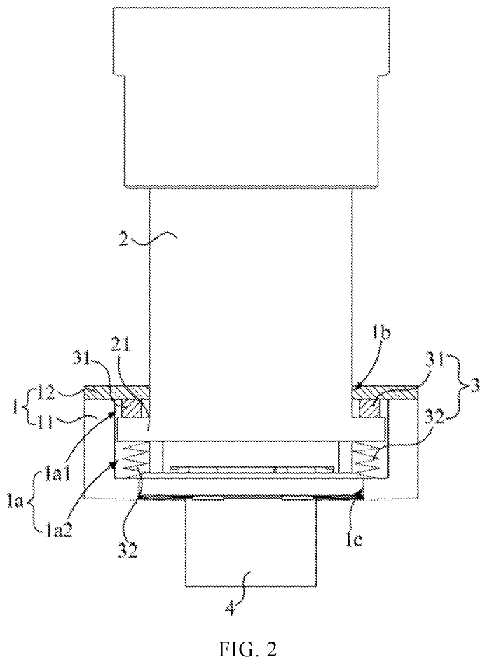

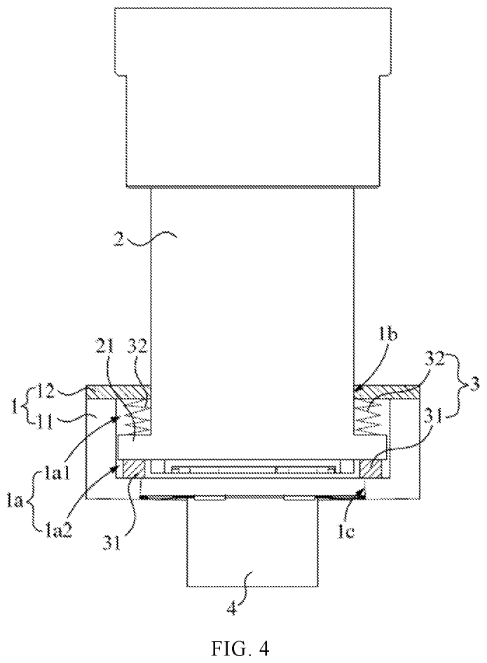

In one embodiment of the present disclosure, as shown in FIG. 1 and FIG. 2, the mounting base 1 is provided with a mounting hole 1b in communication with the accommodation cavity 1a, and the lens 2 penetrates through the mounting hole 1b and is movably provided in the mounting hole 1b: one end of the expansion member 31 distal to the boss 21 abuts against the periphery of the mounting hole 1b, and one end of the elastic member 32 distal to the boss 21 abuts against the bottom wall of the accommodation cavity 1a. Alternatively, as shown in FIG. 3 and FIG. 4, one end of the elastic member 32 distal to the boss 21 abuts against the periphery of the mounting hole 1b, and one end of the expansion member 31 distal to the boss 21 abuts against the bottom wall of the accommodation cavity 1a.

In this embodiment, the lens 2 can slide axially in the mounting hole 1b. Either of the expansion member 31 and the elastic member 32 is located in the first chamber 1a1, and the other of the expansion member 31 and the elastic member 32 is located in the second chamber 1a2. When the expansion member 31 is located in the first chamber 1a1, it abuts against the top wall of the first chamber 1a1, and its end distal to the first chamber 1a1 abuts against the boss 21, so that the expansion member 31 is clamped and confined between the top wall of the first chamber 1a1 and the boss 21. When the expansion member 31 is located in the second chamber 1a2, it abuts against the bottom wall of the second chamber 1a2, and its end distal to the second chamber 1a2 abuts against the boss 21. It can be understood that when the expansion member 31 abuts against the top wall of the first chamber 1a1, the upper and lower ends of the elastic member 32 abut against the bottom wall of the second chamber 1a2 and the boss 21 respectively. When the expansion member 31 abuts against the bottom wall of the second chamber 1a2, the upper and lower ends of the elastic member 32 abut against the top wall of the first chamber 1a1 and the boss 21 respectively. The above two ways of setting up the expansion member 31 and elastic member enable this lens assembly to be used to achieve imaging compensation when the imaging surface thereof moves up and down during heating up, ensuring clear projection images of this lens assembly.

In one embodiment of the present disclosure, as shown in FIGS. 1 and 3, the expansion member 31 and the elastic member 32 are of an annular structure, and the expansion member 31 and the elastic member 32 are sleeved on the outer peripheral wall of the lens 2.

In this embodiment, the expansion member 31 and the elastic member 32 are both made into an annular structure, and both of them are sleeved on the outer peripheral wall of the lens 2 and located respectively on two sides of the boss 21. The expansion member 31 and the elastic member 32 can be in a clearance fit to the outer peripheral wall of the lens 2 to enable axial movement of the lens 2 relative to the expansion member 31 and the elastic member 32, thus achieving the position adjustment of the lens 2. By sleeving the expansion member 31 and the elastic member 32 on the lens 2, it can be ensured that the expansion member 31 can drive the boss 21 to drive the elastic member 32 to deform in the axial direction of the lens 2 when it expands due to its heating up, thus ensuring that the lens 2 can move more accurately in its axial direction, so that after moving, the lens 2 can accurately compensate for the deviation of its imaging plane in the axial direction.

In one embodiment of the present disclosure, as shown in FIGS. 1 and 3, the outer peripheral wall of the boss 21 slidably abut against the inner peripheral wall of the accommodation cavity 1a, and the expansion member 31 fills the first chamber 1a1 or the second chamber 1a2.

In this embodiment, the expansion member 31 can be made of a thermoplastic material such as plastic, so that the expansion member 31 can be molded by injection molding, allowing the expansion member 31 to fill the space inside the first chamber 1a1. This can increase the contact surface between the expansion member 31 and the boss 21 and the top wall of the first chamber 1a1 or the bottom wall of the second chamber 1a2, allowing the expansion member 31 to drive the boss 21 more smoothly when it heats up and expands, which is beneficial for improving the accuracy of image compensation for the lens 2.

In one embodiment of the present disclosure, as shown in FIG. 2 and FIG. 4, the expansion member 31 includes two expansion blocks accommodated and confined in the first chamber 1a1 or the second chamber 1a2, and symmetrically arranged with the optical axis of the lens 2 as the axis of symmetry. Alternatively, the expansion member 31 includes a plurality of expansion blocks accommodated and confined in the first chamber 1a1 or the second chamber 1a2, which are arranged evenly surrounding the lens 2.

In this embodiment, the expansion member 31 can be provided in the first chamber 1a1 or the second chamber 1a2. Regardless of whether the expansion member 31 is provided in the first chamber 1a1 or the second chamber 1a2, the expansion member 31 includes at least two expansion blocks. When the expansion member 31 includes only two expansion blocks, the two expansion blocks are symmetrically provided about the optical axis of the lens 2. As such, when each expansion block is heated and expanded, the two expansion blocks can push against and support two symmetrical locations on the boss 21 about the optical axis of the lens 2, achieving smooth movement of the boss 21 and lens 2 in the direction of the optical axis of the lens 2, ensuring the accuracy of imaging compensation of the lens 2. When the expansion member 31 includes a plurality of expansion blocks, the plurality of expansion blocks are arranged evenly surrounding the lens 2. For example, when the expansion member 31 includes three expansion blocks, the centers of the three expansion blocks are connected in sequence to form an equilateral triangle, and the distances between each expansion block and the optical axis of the lens 2 are equal. Alternatively, when the expansion member 31 includes four expansion blocks, the centers of the four expansion blocks are connected in sequence to form a square, and the distances between each expansion block and the optical axis of the lens 2 are equal. In this way, when each expansion block is heated and expanded, the plurality of expansion blocks can push against and support multiple locations on the boss 21 with equal distance to the optical axis of the lens 2, achieving smooth movement of the boss 21 and lens 2 in the direction of the optical axis of the lens 2, ensuring accuracy of imaging compensation of the lens 2. Preferably, each expansion block has the same linear expansion coefficient, which ensures that each expansion block can produce consistent linear deformation when heating up, thereby ensuring that each expansion block can drive the boss 21 to cause axial movement of the lens 2, avoiding lateral displacement of the lens 2, ensuring smoothness and accuracy of movement of the lens 2, and improving accuracy of imaging compensation of the lens 2.

In one embodiment of the present disclosure, referring to FIGS. 2 and 4, the elastic member 32 includes two springs accommodated and confined in the first chamber 1a1 or the second chamber 1a2, symmetrically arranged with the optical axis of the lens 2 as the axis of symmetry. Alternatively, the elastic member 32 includes a plurality of springs accommodated and confined in the first chamber 1a1 or the second chamber 1a2, arranged evenly surrounding the lens 2.

In this embodiment, the elastic member 32 can be provided in the first chamber 1a1 or the second chamber 1a2. Regardless of whether the elastic member 32 is provided in the first chamber 1a1 or the second chamber 1a2, the elastic member 32 includes at least two springs, which are easy to manufacture and cost-effective, thereby reducing the processing difficulty and material cost of the elastic member 32. When the elastic member 32 includes only two springs, the two springs are symmetrically provided about the optical axis of the lens 2, and the two springs can support two symmetrical locations on the boss 21 when the boss 21 moves, achieving smooth movement of the boss 21 and lens 2 in the direction of the optical axis of the lens 2, ensuring accurate imaging compensation of the lens 2. When the elastic member 32 includes a plurality of springs, the plurality of springs are arranged evenly surrounding the lens 2. For example, when the elastic member 32 includes three springs, the centers of the three springs can be connected in sequence to form an equilateral triangle, and the distances between each spring and the optical axis of the lens 2 are equal. Alternatively, when the elastic member 32 includes four springs, the centers of the four springs can be connected in sequence to form a square, and the distances between each spring and the optical axis of the lens 2 are equal. In this way, each spring can push against and support multiple locations on the boss 21 when it moves about the optical axis of the lens 2, achieving smooth movement of the boss 21 and lens 2 in the direction of the optical axis of the lens 2, ensuring accurate imaging compensation of the lens 2.

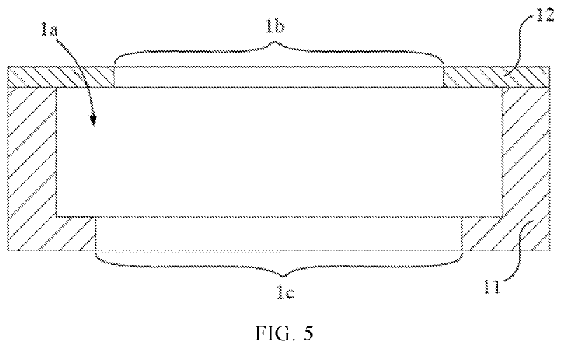

In one embodiment of the present disclosure, referring to FIG. 5 in combination with FIG. 1, the mounting base 1 includes a base body 11 and a cover body 12. The base body 11 is provided with an accommodation slot, and the cover body 12 detachably covers a slot mouth of the accommodation slot and cooperate with a slot wall of the accommodation slot to enclose the accommodation cavity 1a. The lens 2 penetrates through the cover body 12 and is movably provided in the cover body 12.

In this embodiment, the cover 12 can be detachably connected to the base body 11 via screwing engagement, clamping engagement, etc. Accordingly, when the cover 12 is removed from the base body 11, the elastic member 32 and the expansion member 31 can be installed into the accommodation slot of the base body 11 via the slot mouth. In addition, by connecting the cover 12 and the base body 11, the encapsulation of the elastic member 32 and the expansion member 31 in the accommodation cavity 1a may be enabled. Alternatively, the cover 12 may be opened in order to replace the expansion member 31 with a new one with a different expansion coefficient, so that the lens assembly can be adapted to imaging compensation of different lenses 2, improving the versatility of the lens assembly. In addition, the cover 12 can be opened to adjust the positions of the expansion member 31 and the elastic member 32, so that either one of the elastic member 32 and the expansion member 31 is located in the first chamber 1a1, while the other is located in the second chamber 1a2. Finally, by opening the cover 12, it is also possible to achieve maintenance and replacement of the expansion member 31 and the elastic member 32, as well as separate cleaning of the cover 12 and base body 11. Here, a mounting hole 1b in communication with the slot is opened on the cover 12, and the lens 2 is movably provided in the mounting hole 1b of the cover 12, thus achieving the provision of the lens 2 on the cover 12 in a penetrating way.

In one embodiment of the present disclosure, as shown in FIG. 1, the base body 11 is also provided with an assembling hole 1c that penetrates through one side of the base body 11 facing away from the cover body 12 and the bottom wall of the accommodation slot. The assembling hole 1c is configured to install the sensor 4.

In this embodiment, the sensor 4 is used to receive and detect optical signals, and provides the lens 2 with the light source and picture required for projection. The sensor 4 can be a CCD (charge coupled device) sensor or a CMOS (Complementary Metal-Oxide-Semiconductor) sensor. By opening an assembling hole 1c on the base body 11, the sensor 4 can be mounted at the assembling hole 1c, ensuring more reliable and accurate light input from the sensor 4 to the light-incident side of the lens 2, which is beneficial to improving the accuracy and clarity of the picture projection of the lens 2.

The disclosure also proposes a projector, which includes the lens assembly mentioned above.

In this embodiment, the projector includes but is not limited to a DLP (Digital Light Processing) projector and a LCOS (Liquid Crystal on Silicon) projector. You may refer to the above embodiments for the specific structure of the display assembly. Since this projector adopts all the technical solutions of all the above embodiments, it has at least all the beneficial effects brought by the technical solutions of the above embodiments, which will not be elaborated here.

The above-mentioned are only optional embodiments of the disclosure, and are not to limit the scope of the disclosure. Any equivalent structural transformation made using the content of the description and drawings of the disclosure under the inventive concept of the disclosure, or directly/indirectly application thereof in other related technical fields, is included in the scope of patent protection of the disclosure.

1. A lens assembly, comprising:
a mounting base provided with an accommodation cavity;
a lens penetrating through the mounting base and movably provided therein, an outer peripheral wall of the lens being provided with a boss, the boss being located in the accommodation cavity for dividing the accommodation cavity into a first chamber and a second chamber; and
a thermal compensation structure comprising an expansion member and an elastic member, the expansion member and the elastic member being respectively accommodated and confined in the first chamber and the second chamber, the elastic member being configured to coordinate with the expansion member to drive the boss to actuate the lens to move axially when the lens is heated.

2. The lens assembly according to claim 1, wherein the mounting base is provided with a mounting hole in communication with the accommodation cavity, the lens penetrating through the mounting hole and being movably provided therein;
one end of the expansion member distal to the boss abuts against a circumference of the mounting hole, and one end of the elastic member distal to the boss abuts against a bottom wall of the accommodation cavity; or
one end of the elastic member distal to the boss abuts against a circumference of the mounting hole, and one end of the expansion member distal to the boss abuts against a bottom wall of the accommodation cavity.

3. The lens assembly according to claim 1, wherein the expansion member and the elastic member are of an annular structure, and the expansion member and the elastic member are sleeved on the outer peripheral wall of the lens.

4. The lens assembly according to claim 1, wherein an outer peripheral wall of the boss slidably abuts against an inner peripheral wall of the accommodation cavity, and the expansion member fills the first chamber or the second chamber.

5. The lens assembly according to claim 1, wherein the expansion member comprises two expansion blocks accommodated and confined in the first chamber or the second chamber, and symmetrically arranged with an optical axis of the lens as an axis of symmetry; or
the expansion member comprises a plurality of expansion blocks accommodated and confined in the first chamber or the second chamber, and arranged evenly surrounding the lens.

6. The lens assembly according to claim 5, wherein the expansion blocks have same linear expansion coefficients.

7. The lens assembly according to claim 1, wherein the elastic member comprises two springs accommodated and confined in the first chamber or the second chamber, and symmetrically arranged with an optical axis of the lens as the axis of symmetry; or
the elastic member comprises a plurality of springs accommodated and confined in the first chamber or the second chamber, and arranged evenly surrounding the lens.

8. The lens assembly according to claim 1, wherein the mounting base comprises a base body provided with an accommodation slot, and a cover body detachably covering a slot mouth of the accommodation slot, the cover body cooperating with a slot wall of the accommodation slot to enclose the accommodation cavity;
the lens penetrates through the cover body and is movably provided therein.

9. The lens assembly according to claim 8, wherein the base body is further provided with an assembling hole penetrating through one side of the base body facing away from the cover body and penetrating through a bottom wall of the accommodation slot, the assembling hole being adapted for installing a sensor.

10. A projector, comprising a lens assembly according to claim 1.
